(19) United States
(12) Patent Application Publication
(10) Pub. No.: US 2014/0226678 A1
(43) Pub. Date: Aug. 14, 2014

(54) COMMUNICATION APPARATUS AND FRAME PROCESSING METHOD

(71) Applicant: Alaxala Networks Corporation, Kawasaki-shi (JP)

(72) Inventor: Tomohiko KONO, Kawasaki (JP)

(73) Assignee: Alaxala Networks Corporation, Kawasaki-shi (JP)

(21) Appl. No.: 14/035,289

(22) Filed: Sep. 24, 2013

(30) Foreign Application Priority Data
Feb. 14, 2013 (JP) 2013-026889

(51) Int. Cl. H04L 12/935

(52) U.S. Cl. CPC H04L 49/30
USPC 370/419

(57) ABSTRACT

It is provided a communication apparatus for transferring frames, comprising: a controller for controlling operation of the communication apparatus; an interface for inputting/outputting the frames; and a plurality of frame processing parts for processing the input frames. The plurality of frame processing parts each includes: a plurality of storage areas for recording statistics of the frames to be processed; an identifier assigning part for determining, for each of the input frames, one storage area in which the statistics are to be recorded out of the plurality of storage areas, and assigning identification for identifying the determined one storage area to the each of the input frames; and a statistical processing part for updating the statistics that are recorded in the one storage area identified by the identification, by using a result of statistical processing of the frame.

### CLAIM OF PRIORITY

The present application claims priority from Japanese patent application JP 2013-026889 filed on Feb. 14, 2013, the content of which is hereby incorporated by reference into this application.

### BACKGROUND OF THE INVENTION

This invention relates to a communication apparatus for transferring a frame.

JP 2000-13396 A is given as an example of background art in the technical field of this invention. In JP 2000-13396 A, there is disclosed an ATM switch that includes a plurality of processing circuits controlled by software and having a function of collecting and reporting statistical information. The ATM switch includes statistical latch outputting means for outputting a statistical information latch signal to the processing circuits that are collecting statistical information in response to an instruction from the software, statistical information holding means with which the processing circuits detecting the statistical information latch signal hold the statistical information in a statistical information output buffer, and statistical information outputting means for outputting the statistical information held in the statistical information output buffer when a statistical information outputting instruction is received from the software.

### SUMMARY OF THE INVENTION

Some network communication apparatus for transferring an input frame or packet perform statistical processing on a frame or packet to be transferred and record a statistical value. Statistics obtained by such network communication apparatus are used in billing processing, dealing with incidents, and the like, and need to be accurate for these uses.

When obtaining statistical values that are recorded by the conventional network communication apparatus described above, limitations of a data bus for accessing a storage area where the statistical values are stored, or other factors, become a hindrance to obtaining desired statistical values at the same timing in some cases. Accordingly, there is a chance that a plurality of types of statistical values obtained have not been recorded at the same timing due to an update made to statistical values while the statistical values are being obtained.

In the case where a plurality of processing parts execute a plurality of types of statistical processing, a plurality of types of statistical values are not recorded at the same timing in some cases. Obtaining statistical values at certain timing therefore may result in inconsistency among a plurality of types of statistical values, and it is difficult to obtain accurate statistics.

The representative one of inventions disclosed in this application is outlined as follows. There is provided a communication apparatus for transferring frames, comprising: a controller for controlling operation of the communication apparatus; an interface for inputting/outputting the frames; and a plurality of frame processing parts for processing the input frames. The plurality of frame processing parts each includes: a plurality of storage areas for recording statistics of the frames to be processed; an identifier assigning part for determining, for each of the input frames, one storage area in which the statistics are to be recorded out of the plurality of storage areas, and assigning identification for identifying the determined one storage area to the each of the input frames; and a statistical processing part for updating the statistics that are recorded in the one storage area identified by the identification, by using a result of statistical processing of the frame.

According to the exemplary embodiment of this invention, statistical values in a given time range can be obtained. Other objects, configurations, and effects than those described above are made clear in the following description of embodiments.

### BRIEF DESCRIPTION OF THE DRAWINGS

The present invention can be appreciated by the description which follows in conjunction with the following figures, wherein:

FIG. 1 is a block diagram illustrating the configuration of a network system that includes a frame transferring apparatus according to a first embodiment of this invention;

FIG. 2A is a block diagram illustrating the configuration of Rx frame processing part according to the first embodiment;

FIG. 2B is a block diagram illustrating the configuration of Tx frame processing part according to the first embodiment;

FIG. 3 is an explanatory diagram illustrating a configuration example of the statistics database within the statistical processing part according to the first embodiment;

FIG. 4 is a flow chart illustrating frame processing according to the first embodiment;

FIG. 5 is a flow chart illustrating statistical value obtaining processing according to the first embodiment;

FIG. 6 is a flow chart illustrating statistical data reading processing according to the first embodiment;

FIG. 7 is a flow chart illustrating DB_WP updating processing according to the first embodiment;

FIGS. 8A and 8B are explanatory diagrams illustrating examples of commands that are input from the console to the frame transferring apparatus according to the first embodiment;

FIG. 9 is an explanatory diagram illustrating a format of a frame that is output from the DB_WP controller according to the first embodiment;

FIG. 10 is an explanatory diagram illustrating details of DB_WP control according to the first embodiment;

FIG. 11 is an explanatory diagram illustrating an example of statistical processing according to the first embodiment;

FIG. 12 is an explanatory diagram illustrating a configuration example of a statistics database according to the first embodiment;

FIG. 13 is an explanatory diagram illustrating a configuration example of a statistics database within the statistical processing part according to a second embodiment; and

FIG. 14 is an explanatory diagram illustrating an example of statistical processing of the second embodiment.

### DETAILED DESCRIPTION OF THE PREFERRED EMBODIMENTS

A frame transferring apparatus is described below as an example of a network communication apparatus.

### First Embodiment

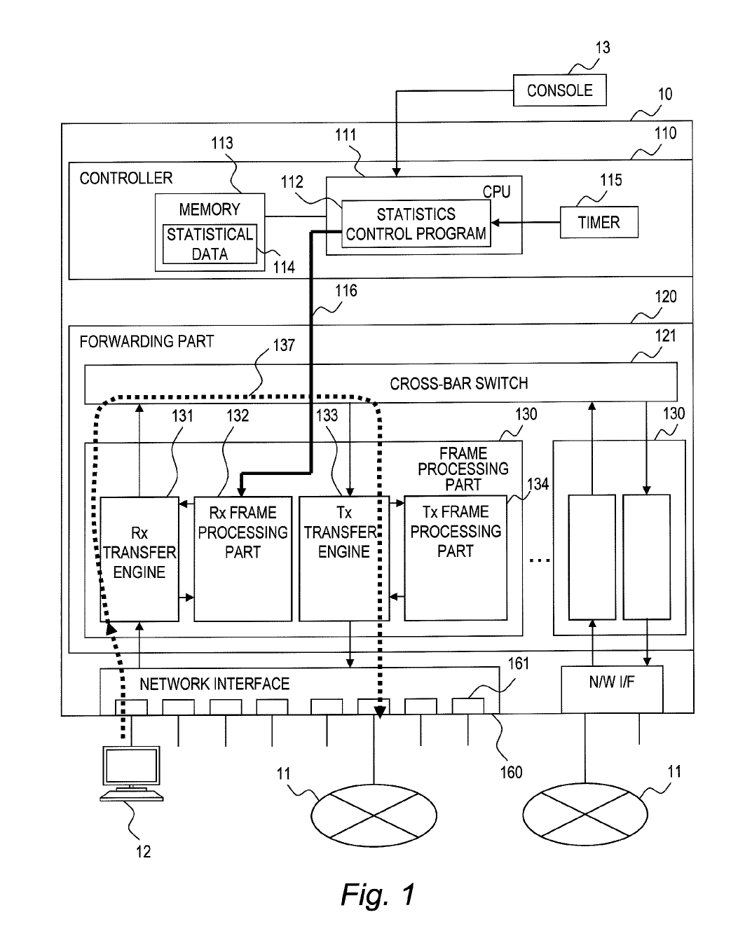

FIG. 1 is a block diagram illustrating the configuration of a network system that includes a frame transferring apparatus according to a first embodiment of this invention.

The frame transferring apparatus of this embodiment, which is denoted by 10, is a router or a switch, and couples a plurality of networks 11 to transfer frames among the plurality of networks 11. The frame transferring apparatus 10 also couples a plurality of computers 12 within each of the networks 11 to transfer frames among the plurality of computers 12.

A console 13 is connected to the frame transferring apparatus 10. The console 13 is a computer that includes a processor, a memory, a communication interface, and an input/output interface, and sends a control instruction that is intended for the frame transferring apparatus 10 (for example, a statistics area switching instruction) based on an instruction from a network administrator. The console 13 is connected to a controller 110 by a given interface (for example, RS232C, a USB, or Ethernet).

The frame transferring apparatus 10 of this embodiment can be any frame transferring apparatus for coupling various networks as long as the frame transferring apparatus is not coupled to a particular network and collects statistics of frames to be transferred.

The frame transferring apparatus 10 includes the controller 110 and a forwarding part 120.

The controller 110 includes a processor 111, a memory 113, and a timer 115.

The processor 111 executes a program stored in the memory 113. The processor 111 of this embodiment in particular executes a statistics control program 112 for controlling statistical processing. The timer 115 sends a given timing signal to the processor 111 (the statistics control program 112).

The memory 113 stores statistical data 114. In the first embodiment, the statistical data 114 is unnecessary after a statistical value is read out of a statistics area and displayed on the console 13 as described later. The statistical data 114 in a second embodiment of this invention includes integrated values of respective statistics.

The statistics control program 112 controls the obtainment of statistics by the frame transferring apparatus 10. The statistics control program 112 outputs a control signal 116 to an Rx frame processing part 132, for example. One of signals that are referred to as the control signal 116 is an statistics area switching instruction for switching the statistics area out of which an obtained statistical value is read.

The forwarding part 120 includes a cross-bar switch 121, a plurality of frame processing parts 130, and at least one network interface 160.

The cross-bar switch 121 connects the frame processing parts 130, and changes the internal connection so that a frame sent from one of the frame processing parts 130 is output to another of the frame processing parts 130 that is connected to a port from which the frame is to be output.

The frame processing parts 130 each include an Rx transfer engine 131, the Rx frame processing part 132, a Tx transfer engine 133, and a Tx frame processing part 134.

The Rx transfer engine 131 refers to a transfer information table to analyze the destination of a frame input to the frame transferring apparatus 10 and determine a port from which the frame is to be output. The Rx transfer engine 131 then sends, to the cross-bar switch 121, the input frame with information about the determined port attached thereto. The Rx transfer engine 131 also sends information about the input frame (for example, the header section of the frame) to the Rx frame processing part 132. The frame information sent to the Rx frame processing part 132 may be the header section of the input frame alone or the entirety of the input frame, depending on what processing is executed in the Rx frame processing part 132.

The Tx transfer engine 133 sends the input frame to one of physical ports 161 that is determined by the information about the output port determined by the Rx frame processing part 132. The Tx transfer engine 133 also sends information about the input frame (for example, the header section of the frame) to the Tx frame processing part 134. The frame information sent to the Tx frame processing part 134 may be the header section of the frame alone or the entirety of the input frame, depending on what processing is executed in the Tx frame processing part 134.

The Rx transfer engine 131 and the Tx transfer engine 133 process an input frame in this manner, thereby transferring the input frame along a path such as a path 137.

The Rx frame processing part 132 and the Tx frame processing part 134 analyze information about frames input to the frame transferring apparatus 10 to obtain statistics of the input frames. Examples of the statistics include the frame transfer amount measured for each destination, and the frame count counted for each destination. The Rx frame processing part 132 and the Tx frame processing part 134 may additionally execute processing of encrypting the input frames.

The frame processing parts 130 are in general built from hardware logic circuits, but may instead be configured from a program executed by the processor.

Each network interface 160 includes the physical ports 161 to which other components such as the networks 11 and the computers 12 are connected. The network interface 160 receives frames transmitted to the frame transferring apparatus 10, and transmits frames output from the frame transferring apparatus 10.

In the embodiment described here, each of the plurality of Rx frame processing parts 132 inside the network communication apparatus (an example of which is a frame transferring apparatus) has at least two statistics areas (denoted by 145 and 146 in the case of the Rx frame processing parts 132), and the same applies to each of the plurality of Tx frame processing parts 134 within the network communication apparatus. The two statistics areas handle two functions, packet processing and statistical value obtainment, respectively.

A DB_WP controller 141 attaches DB_WP information 901 to a packet processed within the network communication apparatus. The packet with the DB_WP information 901 attached thereto reaches the relevant Tx frame processing part 134 via the cross-bar switch 121 and the Tx transfer engine 133. Each Rx frame processing part 132 and each Tx frame processing part 134 refer to the DB_WP information 901 to separately determine which of the two statistics areas is to be used for packet processing, in other words, determine the statistics area in which a statistical value is to be recorded. The two statistics areas switch their functions with each other at a scheduled time (packet processing start timing), or with an input of a packet as a trigger. The switching of the statistics areas is prohibited while a series of packets is being processed, and is executed between different packets. This ensures that the statistics of a series of packets are recorded in the same statistics area.

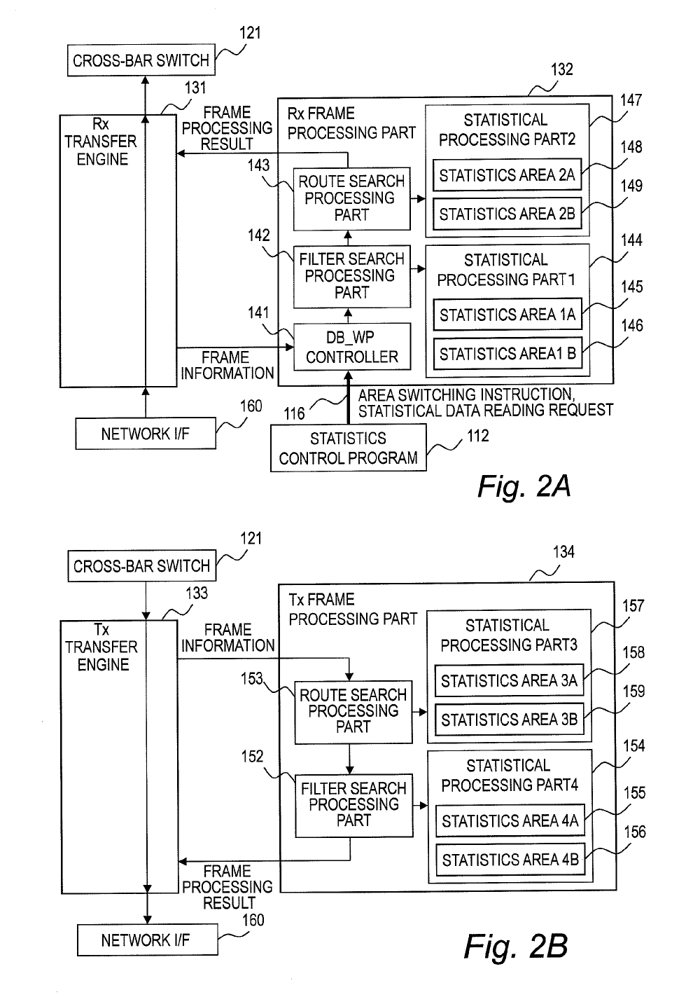

FIG. 2A is a block diagram illustrating the configuration of each Rx frame processing part 132 of the first embodiment.

The Rx frame processing part 132 includes the DB_WP controller 141, a filter search processing part 142, a route search processing part 143, a statistical processing part 1 (144), and a statistical processing part 2 (147).

The DB_WP controller 141 follows the statistics area switching instruction 116 issued by the statistics control program 112 to switch storage areas in which the statistical processing parts 144 and 147 write results of statistical processing. An instruction input from the statistics control program 112 to the DB_WP controller 141 reaches the relevant Tx frame processing part 134 via the filter search processing part 142, the route search processing part 143, the Rx transfer engine 131, the cross-bar switch 121, and the Tx transfer engine 133. Instructions input from the statistics control program 112 to the DB_WP controller 141 include a statistical data reading request in addition to the statistics area switching instruction described above.

The DB_WP controller 141 is not included in each Tx frame processing part 134 as described later. Alternatively, each Tx frame processing part 134 may be provided with the DB_WP controller 141 as well so that the Tx frame processing part 134 can directly receive instructions from the statistics control program 112.

Frame information from the Rx transfer engine 131 is also input to the DB_WP controller 141. The frame information may instead be input to the filter search processing part 142 without the intervention of the DB_WP controller 141.

The filter search processing part 142 filters frames input thereto. For example, the filter search processing part 142 analyzes the header of each input frame, filters a frame that has been transmitted from a specific address or that has a specific address as the destination, and sends, to the statistical processing part 1 (144), the count of filtered frames and/or passed frames as well as a statistics entry number with which the frame count is recorded. A statistics entry number is determined as a result of a route search or filtering processing. The statistical processing part 1 (144) counts the frames filtered by the filter search processing part 142 as a statistical value.

The route search processing part 143 analyzes the header of an input frame to extract information of the frame such as the input/output port and the VLAN, and sends, to the statistical processing part 2 (147), the count of frames from which these pieces of information have been extracted and a statistics entry number with which the frame count is recorded. The statistical processing part 2 (147) counts the frames detected by the route search processing part 143 as a statistical value.

The filter search processing part 142 and the route search processing part 143 may output the size of frames in addition to the counts of detected frames to the statistical processing part 144 and the statistical processing part 147, respectively. Statistical values output by the filter search processing part 142 and the route search processing part 143 may be compiled for each user (by grouping together frames that have a specific user as the sender and/or the destination).

The Rx frame processing part 132 may include other processing parts than the filter search processing part 142 and the route search processing part 143 to process input frames. For instance, the other processing parts may include one for determining whether or not an input frame contains harmful data (e.g., a virus program), removing the harmful frame, and sending the count of harmful frames removed to a statistical processing part. The other processing parts may also execute QoS processing, mirroring, determination about whether a frame is damaged, detection of a control frame (e.g., a frame for controlling a network apparatus), processing of a multicast frame, and the like. Frames on which these types of processing have been performed are counted by statistical processing parts.

The statistical processing part 1 (144) includes a memory. The memory stores a statistics database. The statistics database includes a statistics area 1A (145) and a statistics area 1B (146) as illustrated in FIG. 2A. The statistics area 1A (145) and the statistics area 1B (146) are areas in which statistical values are written and read. To which of the statistics area 1A (145) and the statistics area 1B (146) a statistical value is to be written is selected by DB_WP. DB_WP is managed by the DB_WP controller 141. From which of the statistics area 1A (145) and the statistics area 1B (146) a statistical value is to be read is selected by DB_RP. DB_RP is managed by the respective statistical processing parts.

The description given above on the statistical processing part 1 (144) applies to the statistical processing part 2 (147), which has a similar configuration (a statistics area 2A (148) and a statistics area 2B (149)) and counts frames detected by the route search processing part 143 as a statistical value.

FIG. 2B is a block diagram illustrating the configuration of each Tx frame processing part 134 of the first embodiment.

The Tx frame processing part 134 includes a route search processing part 153, a filter search processing part 152, a statistical processing part 3 (157), and a statistical processing part 4 (154).

Frame information is input to the route search processing part 153 from the Tx transfer engine 133. The route search processing part 153 analyzes the header of an input frame to extract information of the frame such as the input/output port and the VLAN, and sends, to the statistical processing part 3 (157), the count of frames from which these pieces of information have been extracted and a statistics entry number with which the frame count is recorded. The statistical processing part 3 (157) counts the frames detected by the route search processing part 153 as a statistical value.

The filter search processing part 152 filters frames input thereto. For example, the filter search processing part 152 analyzes the header of each input frame, filters a frame that has been transmitted from a specific address or that has a specific address as the destination, and sends, to the statistical processing part 4 (154), the count of filtered frames and/or passed frames as well as a statistics entry number with which the frame count is recorded. The statistical processing part 4 (154) counts the frames filtered by the filter search processing part 152 as a statistical value.

The route search processing part 153 and the filter search processing part 152 may output the size of frames in addition to the counts of detected frames to the statistical processing part 157 and the statistical processing part 154, respectively. Statistical values output by the route search processing part 153 and the filter search processing part 152 may be compiled for each user (by grouping together frames that have a specific user as the sender and/or the destination).

The Tx frame processing part 134 may include other processing parts than the filter search processing part 152 and the route search processing part 153 to process input frames. For instance, the other processing parts may include one for determining whether or not an input frame contains harmful data (e.g., a virus program), removing the harmful frame, and sending the count of harmful frames removed to a statistical processing part. The other processing parts may also execute QoS processing, mirroring, determination about whether a frame is damaged, detection of a control frame (e.g., a frame for controlling a network apparatus), processing of a multicast frame, and the like. Frames on which these types of processing have been performed are counted by statistical processing parts.

The statistical processing part 4 (154) includes a memory. The memory stores a statistics database. The statistics database includes a statistics area 4A (155) and a statistics area 4B (156) as illustrated in FIG. 2B. The statistics area 4A (155) and the statistics area 4B (156) are areas in which statistical values are written and read. To which of the statistics area 4A (155) and the statistics area 4B (156) a statistical value is to be written is selected by DB_WP. DB_WP is managed by the DB_WP controller 141 of the Rx frame processing part 132. From which of the statistics area 4A (155) and the statistics area 4B (156) a statistical value is to be read is selected by DB_RP. DB_RP is managed by the respective statistical processing parts.

The description given above on the statistical processing part 4 (154) applies to the statistical processing part 3 (157), which has a similar configuration (a statistics area 3A (158) and a statistics area 3B (159)) and counts frames detected by the route search processing part 153 as a statistical value.

Each statistical processing part n has two statistics areas, nA and nB, in this embodiment. Alternatively, each statistical processing part (statistics database) may include three or more statistics areas.

The Rx frame processing part 132 and the Tx frame processing part 134 each have two statistical processing parts in this embodiment, but may each have one statistics part instead. In addition, only one of the Rx frame processing part 132 and the Tx frame processing part 134 may have statistical processing parts instead of both of the Rx frame processing part 132 and the Tx frame processing part 134 having statistical processing parts as in this embodiment.

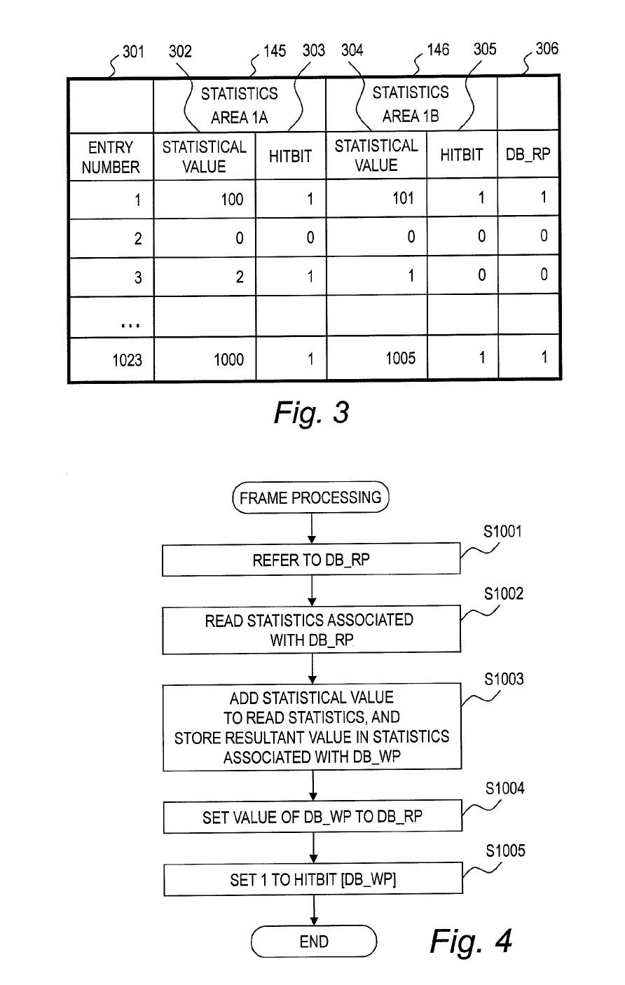

FIG. 3 is a diagram illustrating a configuration example of the statistics database within the statistical processing part 1 (144) of the first embodiment.

The statistics database includes an entry number column 301, a statistics area 1A (145) column, a statistics area 1B (146) column, and a DB_RP column 306.

The entry number column 301 stores a number for uniquely identifying statistics to be collected. The statistics area 1A (145) column and the statistics area 1B (146) column store statistical values. The DB_RP column 306 stores a flag indicating the offset of the address from which a statistical value is read in frame processing, and the flag in this embodiment takes “0” or “1”.

The statistics area 1A (145) and the statistics area 1B (146) are configured from storage areas within the memory of the Rx frame processing part 132 as described above. The offset of the address from which a statistical value is read is controlled by DB_RP stored in the DB_RP column 306, and the offset of the address at which a statistical value is written (DB_WP) is controlled by the DB_WP controller 141.

In the case where the DB_RP column 306 stores “0”, for example, a statistical value is read out of the statistics area 1A (145). In the case where the DB_RP column 306 stores “1”, on the other hand, a statistical value is read out of the statistics area 1B (146). In the case where the value of DB_WP managed by the DB_WP controller 141 is “0”, a statistical value is written in the statistics area 1A (145). In the case where the value of DB_WP managed by the DB_WP controller 141 is “1”, on the other hand, a statistical value is written in the statistics area 1B (146).

Thus, DB_RP is an address offset value in reading out of a storage area, and DB_WP is an address offset value in writing in a storage area. In other words, DB_RP and DB_WP indicate a statistics area from which a statistics value is read and a statistics area to which a statistics value is written, respectively.

When the sizes of the statistics area 1A (145) and the statistics area 1B (146) and the arrangement of the statistics area 1A (145) and the statistics area 1B (146) in the storage area are selected appropriately (for example, 2ⁿ kilobytes such as 1,024 kilobytes), which statistics area is accessed can be selected by accessing an address that is obtained by attaching the value of DB_RP or the value of DB_WP to the most significant bit of the entry number. The value of DB_RP and the value of DB_WP may be address offset values instead of “0” or “1”.

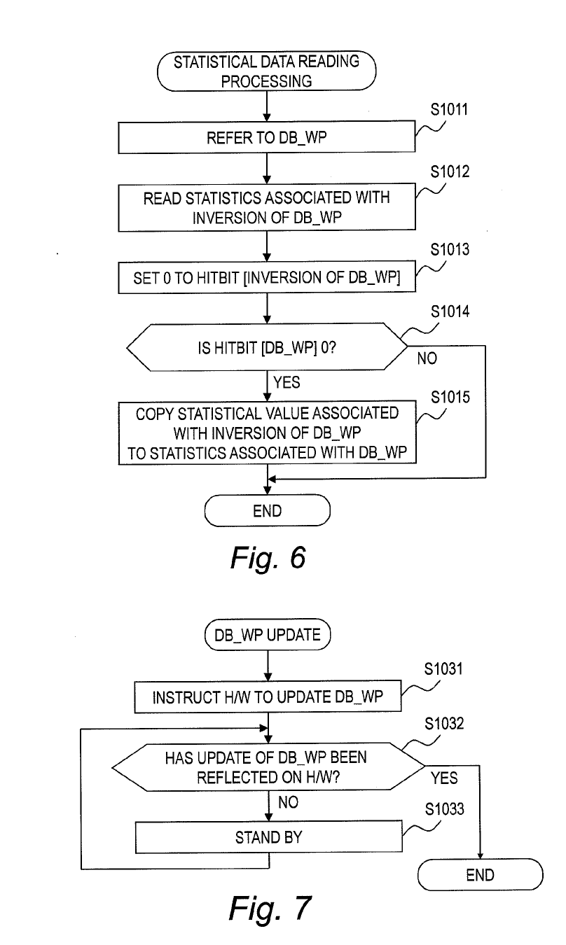

The statistics area 1A (145) column includes a statistical value column 302 and a HITBIT column 303. The statistics area 1B (146) column includes a statistical value column 304 and a HITBIT column 305. The statistical value columns 302 and 304 store statistical values of each entry. The HITBIT columns 303 and 305 each store 1-bit data for holding information about whether a statistical value has been updated after the switching of statistics areas. Specifically, in the case where a statistical value is updated after read out of the current statistics area, the value in the HITBIT column 303 or 305 is “1” (Step S1005 of FIG. 4) and changes to “0” after the statistical value is read out of the statistics area (Step S1013 of FIG. 6).

Other statistical processing parts have statistics databases similar to the statistics database within the statistical processing part 1 (144) of which a configuration example has been described. In the following description, the statistical area nA of each statistical processing part n out of the plurality of statistical processing parts is referred to as “statistics area A”, and the statistical area nB of each statistical processing part n out of the plurality of statistical processing parts is referred to as “statistics area B”.

By providing HITBIT in each statistics area, accurate statistical values can be read out also when statistical values are not updated in a frame processing period as described above.

FIG. 4 is a flow chart of frame processing of the first embodiment. The frame processing of FIG. 4 is executed by the Rx frame processing part 132 of each of the frame processing parts 130 when a frame is input. The same processing is executed by other Rx frame processing parts and the Tx frame processing parts as well.

The Rx frame processing part 132 first refers to DB_RP (S1001) and reads a statistical value out of a statistics area that is indicated by DB_RP (S1002). Specifically, the Rx frame processing part 132 reads a statistical value stored in the statistics area A when DB_RP is “0”, and reads a statistical value stored in the statistics area B when DB_RP is “1”. By reading a statistical value out of a statistics area that is indicated by DB_RP, the latest statistical values are extracted from a plurality of statistics areas.

Thereafter, the Rx frame processing part 132 adds a statistical value of the input frame to the read statistics, and writes the resultant statistical value in a statistics area that is indicated by DB_WP, thereby updating the statistical value (S1003).

The value of DB_WP is then set to DB_RP (S1004). DB_WP indicates in which statistics area data is updated. By setting the value of DB_WP to DB_RP, a statistics area in which data is updated last through DB_RP can therefore be managed so that a statistical value is read out of the last updated statistics area.

Subsequently, “1” is set to HITBIT for the updated statistical value in the statistics area indicated by DB_WP, thus storing the fact that the statistical value has been updated (S1005).

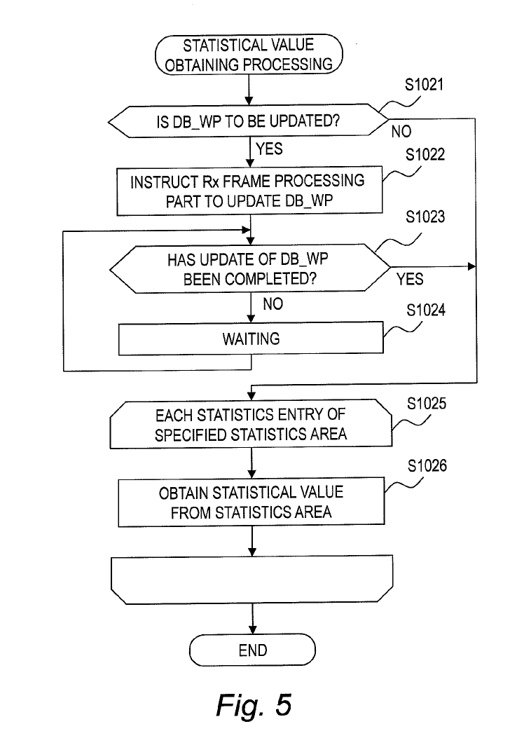

FIG. 5 is a flow chart of statistical value obtaining processing of the first embodiment. The statistical value obtaining processing of FIG. 5 is executed by the statistical value control program 112 when a statistics obtaining request is input from the console 13. While the Rx frame processing parts 132 are processing targets in FIG. 5, other frame processing parts (the Tx frame processing parts 134 and frame processing parts of other distributed processing parts) can be the processing targets.

The statistics control program 112 first determines whether to update DB_WP (S1021). DB_WP can be updated when a given condition is fulfilled (for example, every second (in the case where the second has 0 after the decimal point). This is for switching to the obtaining side so that the updated statistics, which have been on the recording side and have not been visible to users, are made visible to the users. Updating DB_WP regularly, for example, can prevent statistics from looking as though not having been updated even though an explicit command is not used. When DB_WP is updated, the current (latest) statistical values can be obtained and old statistical values are obtained when DB_WP is not updated.

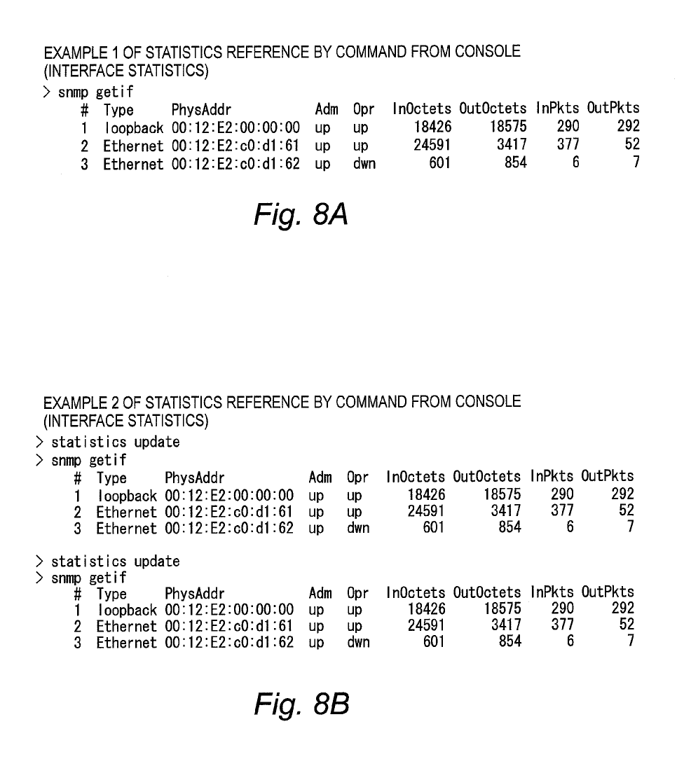

The input of a command for switching statistics areas, which is illustrated in FIG. 8B, may be judged as a basis for determining that DB_WP is to be updated.

When it is determined as a result that DB_WP is to be updated, the statistics control program 112 proceeds to Step S1022 in order to wait for the time to update DB_WP. When DB_WP is not to be updated, on the other hand, the statistics control program 112 proceeds to Step S1025 without waiting for the time to update DB_WP.

In Step S1022, the statistics control program 112 instructs each Rx frame processing part 132 to update DB_WP. The statistics control program 112 waits until a given condition is fulfilled and an update of DB_WP is completed (S1023 and S1024). After updating DB_WP, the Rx frame processing part 132 writes an update completion flag in a given storage area. The statistics control program 112 repeatedly checks whether the update completion flag has been written in the given storage area, and once confirming that the update completion flag has been written, proceeds to Step S1025 (S1023). The waiting in Step S1024 may last until the timer finishes counting the longest time required to fulfill the given condition, or may last until the completion of processing of the received frame is confirmed by monitoring the status of frame processing.

After subsequently confirming that the transmitted switching instruction has been granted, the statistics control program 112 obtains a statistical value of each statistics entry from the specified statistics area (S1025 and S1026).

FIG. 6 is a flow chart of statistical data reading processing of the first embodiment. The statistical data reading processing of FIG. 6 is executed by the Rx frame processing part 132 of each of the frame processing parts 130 when the statistics control program 112 requests the reading of statistical data (for instance, S1026 of FIG. 5). The same processing is executed by other Rx frame processing parts and the Tx frame processing parts as well.

The Rx frame processing part 132 of the frame processing part 130 first refers to DB_WP (S1011) and reads a statistical value out of a statistics area opposite of the area that is indicated by DB_WP (the inversion of DB_WP) (S1012). Specifically, the Rx frame processing part 132 reads a statistical value stored in the statistics area B when DB_WP is “0”, and reads a statistical value stored in the statistics area A when DB_WP is “1”. By reading a statistical value out of a statistics area opposite of the area that is indicated by DB_WP, statistical value reading is accomplished without being affected by an update made to the statistical value by the frame processing.

Thereafter, “0” is set to every HITBIT in the statistics area that is the inversion of the area indicated by DB_WP (S1013).

The Rx frame processing part 132 then determines whether HITBIT is “0” in an entry in question of the statistics area indicated by DB_WP (S1014). When HITBIT is “0”, a statistical value of the statistics area opposite of the area that is indicated by DB_WP is copied to a statistical value of the statistics area indicated by DB_WP for this entry (S1015). The value of HITBIT being “0” in the statistics area indicated by DB_WP means that a statistical value of the entry in question has not been updated by the frame processing. An update to the latest statistical value is therefore executed by copying to the statistical value of the statistics area indicated by DB_WP.

FIG. 7 is a flow chart of DB_WP updating processing of the first embodiment. The DB_WP updating processing of FIG. 7 is executed by the statistics control program 112 when DB_WP is to be updated explicitly with the input of a command from the user or the like as a trigger. The command input by the user is, for example, “statistics update”.

The statistics control program 112 first instructs the relevant frame processing part 130 to update DB_WP (S1031). The statistics control program 112 stands by until the update of DB_WP is completed (S1033), and ends the DB_WP updating processing after the update of DB_WP is completed (S1032).

FIGS. 8A and 8B are diagrams illustrating examples of a command that is input from the console 13 to the frame transferring apparatus 10 of the first embodiment.

Inputting an “snmp getif” command for obtaining a statistical value which is illustrated in FIG. 8A from the console 13 switches the statistics area from which a statistical value is to be obtained, and a statistical value is obtained from the new statistics area.

A command for switching statistics areas may be provided. For instance, to switch statistics areas, a “statistics update” command illustrated in FIG. 8B is input from the console 13, thereby updating DB_RP and switching the statistics area from which a statistic value is to be obtained. A statistics value is obtained by subsequently inputting the “snmp getif” command from the console 13.

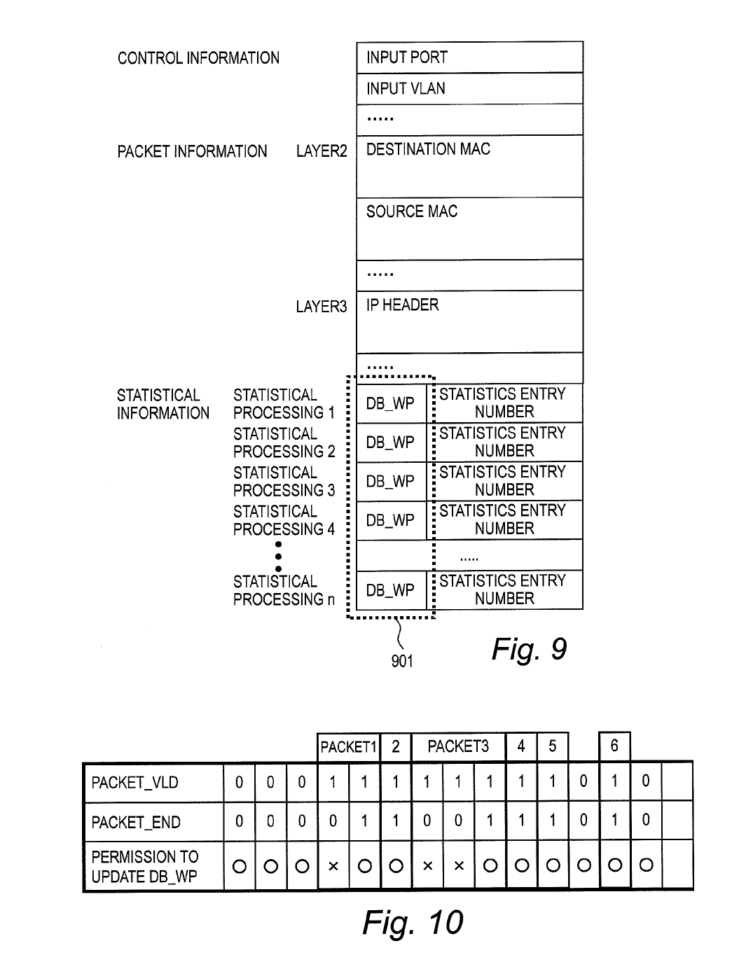

FIG. 9 is a diagram illustrating the format of a frame that is output from the DB_WP controller 141 of the first embodiment.

The DB_WP controller 141 attaches DB_WP information to a frame input from the Rx transfer engine 131, and outputs the resultant frame to the filter search processing part 142.

Specifically, a frame input to the DB_WP controller 141 contains control information (the input port, the input VLAN, and the like), frame information, and statistical information. The input frame may contain user data, for example. The frame information includes a destination MAC address and source MAC address of Layer 2, and further includes an IP header of Layer 3 and the like. The statistical information includes statistics entry numbers of statistical processing in which this frame is to be processed.

In this embodiment, the statistical information of a frame output from the DB_WP controller 141 includes the DB_WP information 901 for each statistics type of the relevant Rx frame processing part 132 and the relevant Tx frame processing part 134 (for each statistical processing part). The DB_WP information 901 indicates a storage area in which a value obtained by performing statistical processing on this frame is to be written. The DB_WP information 901 is attached to a frame to be referred to by each Rx frame processing part and each Tx frame processing part within the frame transferring apparatus. Results of statistical processing performed by the plurality of Rx frame processing parts and the plurality of Tx frame processing parts on the same frame are thus written in the same statistics area that is indicated by DB_WP.

The frame illustrated in FIG. 9 is in a state that a frame output from the DB_WP controller 141 is in, meaning that statistical processing has not been performed on the frame yet. Statistics entry numbers in FIG. 9 are therefore indeterminate (undetermined).

FIG. 10 is a diagram illustrating details of DB_WP control of the first embodiment. The timing of updating DB_WP, namely, the timing of starting the use of new DB_WP instructed to be updated to from the next round of frame processing, is described with reference to FIG. 10.

In FIG. 10, PACKET_VLD is a flag indicating whether the frame processing is valid, and is “1” during the frame processing and “0” when the frame processing is not being executed. PACKET_END is a flag indicating the end of the same round of frame processing, and is “1” at the time when the last frame is processed in the processing of a series of frames, and “0” at other times.

The DB_WP controller 141 of this embodiment switches the storage area in which a statistical value is to be recorded in response to the statistics area switching instruction 116 issued from the statistics control program 112. The switch is made at this timing in order to avoid switching statistics areas in the middle of processing a series of frames.

To give an example, in a method that uses the flags PACKET_VLD and PACKET_END described above, an update of DB_WP is granted when PACKET_VLD is “0”, or when PACKET_VLD is “1” while PACKET_END is “1”. In short, DB_WP is updated at a time when (PACKET_VLD=0) or (PACKET_VLD=1 and PACKET_END=1) is satisfied.

In a second method, an update of DB_WP is granted when PACKET_VLD is not “1” or PACKET_END is not “0”. In short, DB_WP is updated at a time when not (PACKET_VLD=1 and PACKET_END=0) is satisfied.

By controlling the timing of updating DB_WP in this manner, the switching of statistics areas is prohibited during statistical processing related to a series of frames, and only the switching of statistics areas between one series of frames and a different series of frames is permitted. Recording processing of a series of frames across different statistics areas is thus avoided. With statistics about one input frame recorded in the same statistics area, accurate statistics of frame processing can be obtained.

This processing of a series of frames is, for example, a case of processing copies of the same frame as a series of frames when a plurality of frames created by copying one multicast frame are output. A multicast frame is copied by the cross-bar switch 121 or the Tx transfer engine 133.

Each Tx frame processing part 134 refers to the frame processing status in order to ensure that statistics of frames that have been processed prior to an update of DB_WP have been taken. Specifically, this may be accomplished by determining whether the frames constitute a series of frames with the use of DB_WP. For instance, when DB_WP is “1”, obtaining a statistics value from a statistics area that satisfies DB_WP=1 is postponed until the recording of statistics in the statistics area that satisfies DB_WP=1 is finished. In another example of implementation, the reading of a statistical value may be prohibited for a standard or maximum length of time required to finish processing all copies of a frame copied by the cross-bar switch 121.

In the case where the frame transferring apparatus is an L3 switch, processing as a switch in Layer 2 and processing as a router in Layer 3 are executed in parallel. Frame copies in Layer 2 and frame copies in Layer 3 may therefore be determined as a series of frames in this case.

Through this processing, obtaining a statistical value can be prohibited for a period from the change of DB_WP value to the completion of the taking of statistics about a series of frames.

FIG. 11 is a diagram illustrating an example of statistical processing of the first embodiment, and illustrates changes made to statistical values and flags in a particular entry by packet processing.

In FIG. 11, DB_WP is a flag indicating to which statistics area a statistical value is to be written, and is managed with the use of 1-bit data set for each statistics type. Statistical values of the statistics area A and statistical values of the statistics area B are recorded for each statistics type and for each entry. DB_RP is a flag indicating a statistics area in which a statistical value has been written last, and is managed with the use of 1-bit data set for each statistics type and for each entry. HITBIT of the statistics area A is a flag indicating that a statistical value of the statistics area A has been updated due to frame processing after the switching of statistics areas, and is recorded for each statistics type and for each entry. HITBIT of the statistics area B is a flag indicating that a statistical value of the statistics area B has been updated due to frame processing after the switching of statistics areas, and is recorded for each statistics type and for each entry.

First, a packet is processed (201) in the statistics area A (DB_WP=0) and a statistical value of the statistics area A is changed from “0” to “1”. With the statistical value of the statistics area A updated, HITBIT of the statistics area A is set to “1”. An addition is then made to the statistical value of the statistics area A by packet processing.

Thereafter, a statistical value of the statistics area B is read (202). The first embodiment employs a read and clear method in which a statistical value is cleared when read. The statistical value and HITBIT of the statistics area B are accordingly cleared. However, the statistical value and the value of HITBIT are “0” at this time and therefore do not change.

Thereafter, at the time when the addition is made to the statistical value of the statistics area A by the packet processing and the packet processing is ended, the statistics area in which a statistical value is to be recorded is switched from the statistics area A to the statistics area B (203). A statistical value is consequently written in the switched-to statistics area B and the statistical value of the statistics area B is updated from “0” to “1”. With the statistical value of the statistics area B updated, HITBIT of the statistics area B is set to “1”. An addition is then made to the statistical value of the statistics area B by packet processing.

The statistical value of the statistics area A is then read (204). In the first embodiment where the read and clear method for clearing a statistical value at the time of reading is employed, the statistical value and HITBIT of the statistics area A are cleared.

Thereafter, at the time when the addition is made to the statistical value of the statistics area B by the packet processing and the packet processing is ended, the statistics area in which a statistical value is to be recorded is switched from the statistics area B to the statistics area A (205). A statistical value is consequently written in the switched-to statistics area A and the statistical value of the statistics area A is updated from “0” to “1”. With the statistical value of the statistics area A updated, HITBIT of the statistics area A is set to “1”.

The statistical value of the statistics area B is then read (206). In the first embodiment where the read and clear method for clearing a statistical value at the time of reading is employed, the statistical value and HITBIT of the statistics area B are cleared.

In the first embodiment where a statistical value is cleared when read out of a statistics area in this manner, the statistics control program 112 manages integrated values of statistics. This requires the memory to have a large storage capacity but simplifies control of each Rx frame processing part 132.

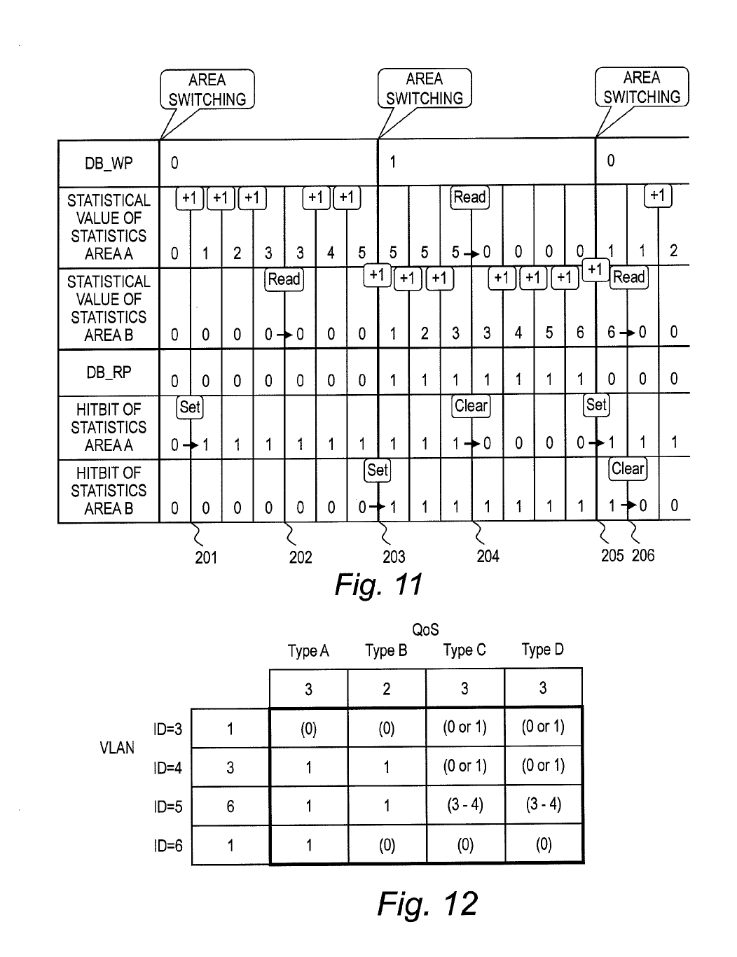

FIG. 12 is a diagram illustrating a configuration example of a statistics database of the first embodiment.

In the statistics database example of FIG. 12, the count of frames processed by a VLAN and the count of frames processed by a type of QoS are recorded. For instance, one frame is processed by VLAN3, three frames are processed by VLAN4, six frames are processed by VLAN5, and one frame is processed by VLAN6. Three frames are processed by Type A of QoS, two frames are processed by Type B, three frames are processed by Type C, and three frames are processed by Type D. Five types of statistics, 4A, 4B, 5A, 5B, and 5C are obtained as statistics about combinations of a VLAN and a QoS type.

The statistical values of these combinations are mapped onto a QoS-VLAN matrix and analyzed as illustrated in FIG. 12. The matrix shows that 3A, 3B, and 6B have a value “0”. None of 3C to 5D settles at a unique value, although an estimation of a certain range can be made on their values.

Thus, in the first embodiment where statistical values of different types (for example, QoS and VLAN) are recorded at the same timing, a statistical value can be estimated for a combination of which a statistical value is not obtained.

As has been described, in the first embodiment of this invention, each Rx frame processing part 132 transfers a frame with DB_WP information attached thereto so that the statistics area in which results of statistical processing by the Rx frame processing part 132 are recorded is switched by DB_WP, and statistical values about a series of frames are thus recorded in the same statistics area.

In addition, the timing of reading a statistical value does not include the timing of switching statistics areas, thereby avoiding reading the statistical value before and after the time when statistics areas are switched.

Moreover, a statistical value can be read without being affected by frame processing because a statistics area to which a statistical value is written by frame processing and a statistics area from which a statistical value is read are separate areas.

### Second Embodiment

The second embodiment of this invention is described next.

In the second embodiment, a statistical value is initialized to “0” each time statistics areas are switched, and the statistical value before the switching of statistics areas and the statistical value after the switching of statistics areas are integrated by the statistics control program 112. The second embodiment therefore does not include DB_RP.

The description of the second embodiment focuses on configurations and processing that differ from the first embodiment described above, and descriptions on configurations and processing that are the same as those in the first embodiment are omitted here.

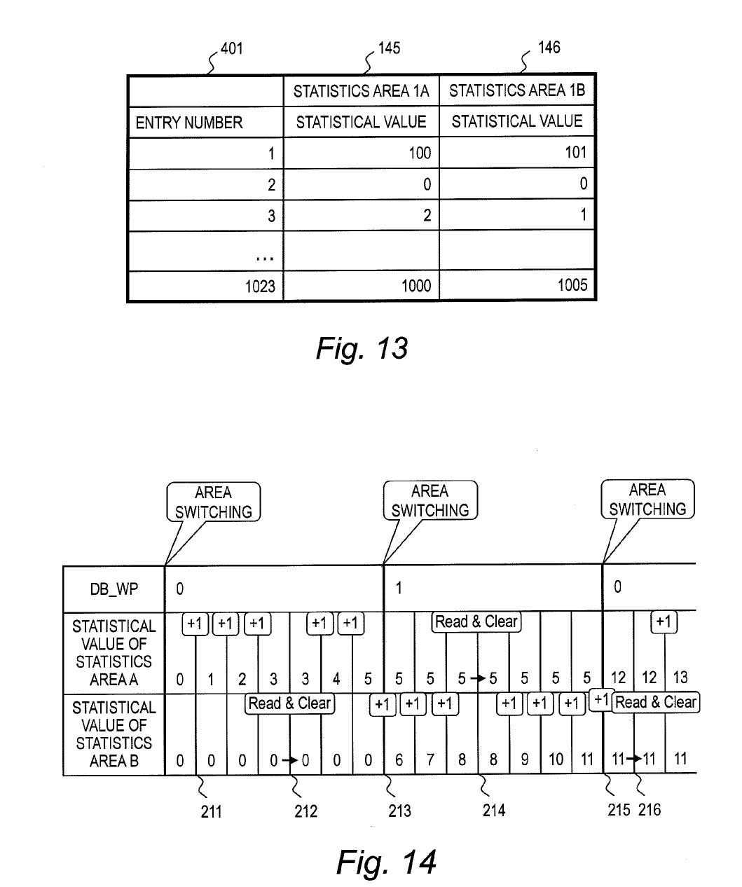

FIG. 13 is a diagram illustrating a configuration example of a statistics database within the statistical processing part 1 (144) of the second embodiment. The description given here on the configuration example of the statistics database within the statistical processing part 1 (144) applies to other statistical processing parts, which have similar statistics databases.

The statistics database includes an entry number column 401, a statistics area 1A (145) column, and a statistics area 1B (146) column.

The entry number column 401 stores a number for uniquely identifying statistics to be collected. The statistics area 1A (145) column and the statistics area 1B (146) column store statistical values. The statistics area 1A (145) and the statistics area 1B (146) are configured from storage areas within the memory of their own Rx frame processing part 132 as described above. The offset of the address at which a statistics area is accessed is controlled by the DB_WP controller 141.

In the case where the value of DB_WP managed by the DB_WP controller 141 is “0”, for example, a statistical value is written in the statistics area 1A (145) and a statistical value is read out of the statistics area 1B (146). In the case where the value of DB_WP is “1”, a statistical value is written in the statistics area 1B (146) and a statistical value is read out of the statistics area 1A (145).

When the sizes of the statistics area 1A (145) and the statistics area 1B (146) and the arrangement of the statistics area 1A (145) and the statistics area 1B (146) in the storage area are selected appropriately (for example, 2ⁿ kilobytes such as 1,024 kilobytes), which statistics area is accessed can be selected by accessing an address that is obtained by attaching the value of DB_WP to the most significant bit of the entry number. The value of DB_WP may be address offset values instead of “0” or “1”.

Frame processing of the second embodiment is described next. The frame processing of the second embodiment is executed by the Rx frame processing part 132 of each of the frame processing parts 130 when a frame is input. The same processing is executed by other Rx frame processing parts and the Tx frame processing parts as well.

In the second embodiment, the Rx frame processing part 132 of the frame processing part 130 first refers to DB_WP and reads a statistical value out of a statistics area that is indicated by an identifier recorded in DB_WP. Specifically, the Rx frame processing part 132 reads a statistical value stored in the statistics area A when DB_WP is “0”, and reads a statistical value stored in the statistics area B when DB_WP is “1”. Reading a statistical value out of a statistics area that is indicated by DB_WP ensures that the read statistical value is always the latest statistical value.

Thereafter, the Rx frame processing part 132 adds a statistical value of the input frame to the read statistics, and writes the resultant statistical value in a statistics area that is indicated by DB_WP, thereby updating the statistical value.

Statistical data reading processing of the second embodiment is described next. The statistical data reading processing of the second embodiment is executed by the Rx frame processing part 132 of each of the frame processing parts 130 when the statistics control program 112 requests the reading of statistical data (for instance, S1026 of FIG. 5). The same processing is executed by other Rx frame processing parts and the Tx frame processing parts as well.

The Rx frame processing part 132 first refers to DB_WP and reads a statistical value out of a statistics area opposite of the area that is indicated by DB_WP (the inversion of DB_WP), and clears the statistical value of the read statistics area with 0. Specifically, the Rx frame processing part 132 reads a statistical value stored in the statistics area B when DB_WP is “0”, and reads a statistical value stored in the statistics area A when DB_WP is “1”. By reading a statistical value out of a statistics area opposite of the area that is indicated by DB_WP, statistical value reading is accomplished without being affected by an update made to the statistical value by the frame processing.

FIG. 14 is a diagram illustrating an example of statistical processing of the second embodiment, and illustrates changes made to statistical values and flags in a particular entry by packet processing.

Each statistics database of the second embodiment does not include DB_RP and HITBIT as described above with reference to FIG. 13.

First, a packet is processed (211) in the statistics area A (DB_WP=0) and a statistical value of the statistics area A is updated from “0” to “1”. An addition is then made to the statistical value of the statistics area A by packet processing.

Thereafter, a statistical value of the statistics area B is read (212). In the second embodiment, statistical values are not cleared when read. However, the statistical value is “0” at this time.

Thereafter, at the time when the addition is made to the statistical value of the statistics area A by the packet processing and the packet processing is ended, the statistics area in which a statistical value is to be recorded is switched from the statistics area A to the statistics area B (213). A value obtained by adding a statistical value of the packet processing to the statistical value of the statistics area A is consequently written in the switched-to statistics area B, and the statistical value of the statistics area B is updated from “0” to “6”. An addition is then made to the statistical value of the statistics area B by packet processing.

The statistical value of the statistics area A is then read (214). In the second embodiment, statistical values are not cleared when read.

Thereafter, at the time when the addition is made to the statistical value of the statistics area B by the packet processing and the packet processing is ended, the statistics area in which a statistical value is to be recorded is switched from the statistics area B to the statistics area A (215). A value obtained by adding a statistical value of the packet processing to the statistical value of the statistics area B is consequently written in the switched-to statistics area A, and the statistical value of the statistics area A is updated from “5” to “12”.

The statistical value of the statistics area B is then read (216). In the second embodiment, statistical values are not cleared when read.

In the case where packet processing is not executed during a period between the switching of statistics areas and the reading of statistics, compensation processing (for example, processing of reading a statistical value out of the opposite statistics area) is required in the second embodiment.

As has been described, in the second embodiment where statistical values are not cleared when read out of statistics areas, an integrated value of statistics is managed in a statistics area that is indicated by the value of DB_WP. This complicates control of each Rx frame processing part 132, but eliminates the need for the statistics control program 112 to manage integrated values of statistics. Accordingly, a portion of a memory that has been allocated to store a statistical value can be freed up once the statistical value is read out of a statistics area and displayed on the console 13, which means that the storage capacity required of the memory can be reduced.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card. The drawings shows control lines and information lines as considered necessary for explanation but do not show all control lines or information lines in the products. It can be considered that almost of all components are actually interconnected.

What is claimed is:

1. A communication apparatus for transferring frames, comprising:
a controller for controlling operation of the communication apparatus;
an interface for inputting/outputting the frames; and
a plurality of frame processing parts for processing the input frames,
wherein the plurality of frame processing parts each includes:
a plurality of storage areas for recording statistics of the frames to be processed;
an identifier assigning part for determining, for each of the input frames, one storage area in which the statistics are to be recorded out of the plurality of storage areas, and assigning identification for identifying the determined one storage area to the each of the input frames; and
a statistical processing part for updating the statistics that are recorded in the one storage area identified by the identification, by using a result of statistical processing of the frame.

2. The communication apparatus according to claim 1,
wherein the controller is configured to instruct the identifier assigning part to switch the one storage area in which the statistics are to be recorded, and
wherein the identifier assigning part determines the identification in response to the switching instruction transmitted from the controller.

3. The communication apparatus according to claim 2,
wherein the plurality of frame processing parts each identify a series of frames among the frames to be processed, and switches the one storage area in which the statistics are to be recorded after the statistical processing is completed for the identified series of frames, and
wherein the controller is configured to obtain a statistical value from another of the plurality of storage areas, which is different from the one storage area in which the statistics are to be recorded after the one storage area in which the statistics are to be recorded is switched.

4. The communication apparatus according to claim 1, wherein the controller is configured to:
obtain a statistical value from another of the plurality of storage areas, which is different from the one storage area in which the statistics are to be recorded; and
use the obtained statistical value to generate data to be presented to a user.

5. The communication apparatus according to claim 4, wherein the statistical processing part deletes the obtained statistical value after the controller is configured to obtain the statistical value.

6. The communication apparatus according to claim 5, wherein the controller holds the statistical value obtained from the another of the plurality of storage areas, combines the held statistical value with a statistical value newly obtained from the another of the plurality of storage areas, and present the combined value to the user as a statistical value.

7. The communication apparatus according to claim 1, wherein the statistical processing part manages a flag that indicates an update made to a statistical value of the one storage area after the one storage area in which the statistics are to be recorded is switched.

8. The communication apparatus according to claim 7, wherein a statistical value of another of the plurality of storage areas to the one storage area in which the result of the statistical processing is to be recorded in a case where the flag indicates that the statistical value of the one storage area is yet to be updated when the controller obtains the statistical value, the statistical processing part copies.

9. The communication apparatus according to claim 1, wherein the statistical processing part copies a statistical value of another of the plurality of storage areas to the one storage area in which the result of the statistical processing is to be recorded when the storage area in which the statistics are to be recorded is switched.

10. The communication apparatus according to claim 1, wherein the statistical processing part obtains information of a virtual network from the input frames, and obtains, as the result of the statistical processing, at least one of a count of frames relevant to the virtual network whose information has been obtained and a size of the frames.

11. A frame processing method for use in a communication apparatus for transferring frames,
the communication apparatus including a controller for controlling operation of the communication apparatus, an interface for inputting/outputting the frames, and a plurality of frame processing parts for processing the input frames,
the plurality of frame processing parts each including a plurality of storage areas for recording statistics of the frames to be processed,
the frame processing method including the steps of:
determining, by the each of the plurality of frame processing parts, for each of the input frames, one storage area in which the statistics are to be recorded out of the plurality of storage areas;
assigning, by the each of the plurality of frame processing parts, identification for identifying the determined one storage area to the each of the input frames; and
updating, by the each of the plurality of frame processing parts, the statistics that are recorded in the one storage area identified by the identification, by using a result of statistical processing of the frame.

12. The frame processing method according to claim 11, further including the steps of:
instructing, by the controller, the each of the plurality of frame processing parts to switch the one storage area in which the statistics are to be recorded; and
determining, by the each of the plurality of frame processing parts, the identification in response to the switching instruction transmitted from the controller.

13. The frame processing method according to claim 12, further including the steps of:
identifying, by the each of the plurality of frame processing parts, a series of frames among the frames to be processed;
switching, by the each of the plurality of frame processing parts, the one storage area in which the statistics are to be recorded after the statistical processing is completed for the identified series of frames; and
obtaining, by the controller, a statistical value from another of the plurality of storage areas, which is different from the one storage area in which the statistics are to be recorded after the one storage area in which the statistics are to be recorded is switched.

14. The frame processing method according to claim 11, further including the steps of:
obtaining, by the controller, a statistical value from another of the plurality of storage areas, which is different from the one storage area in which the statistics are to be recorded; and
using, by the controller, the obtained statistical value to generate data to be presented to a user.

15. The frame processing method according to claim 11, further including the step of managing, by the each of the plurality of frame processing parts, a flag that indicates an update made to a statistical value of the one storage area after the one storage area in which the statistics are to be recorded is switched.
